(19) United States
(12) Patent Application Publication
(10) Pub. No.: US 2008/0265058 A1
(43) Pub. Date: Oct. 30, 2008

(54) ROTOR NOZZLE FOR A CLEANING DEVICE

(76) Inventor: MARTIN F. WIMMER, SHANGHAI (CN)

Correspondence Address: SHUTTLEWORTH & INGERSOLL, P.L.C., 115 3RD STREET SE, SUITE 500, P.O. BOX 2107, CEDAR RAPIDS, IA, 52406, US

(21) Appl. No.: 12/110,845

(22) Filed: Apr. 28, 2008

(30) Foreign Application Priority Data
Apr. 26, 2007 (DE) 20 2007 006 088

(51) Int. Cl. B05B 3/06

(52) U.S. Cl. 239/258

(57) ABSTRACT

A rotary nozzle for a cleaning device, specifically for a high pressure cleaning device. The device has a housing with a fluid inlet and outlet for the passage of the fluid. Within the housing, there is a nozzle body traversed and rotated by the fluid. The rotary nozzle body is designed so that it will not be in direct contact with the housing's inner surface during rotation, but rather a fluid film is built up around the nozzle body. The fluid film is created because the nozzle body does not rotate around its own center axis, but only around the center axis of the housing.

This application claims the priority of German application DE 20 2007 006 088.2 filed Apr. 26, 2007.

### BACKGROUND OF THE INVENTION

This invention relates to a rotary nozzle used on a cleaning device, especially a high pressure cleaning device. Furthermore, it relates to the improved function and the reduced production cost of a rotary nozzle body for such devices.

Rotary nozzles for cleaning devices are known in their state of the art, especially as shown in the European patents EP915739B1 and EP1719557B1, and in the U.S. patent application Ser. No. 11/381,489 the last two being inventions by the same inventor of the current application.

In the state of the art rotary nozzles, the rotary nozzle body is protected against wear towards its outer housing and vice versa by using at least one O-ring or another device having a supporting function. Also, in the state of the art rotary nozzles the rotary nozzle bodies are assemblies of more than one part due to parts needed for the supporting function or other parts needed to add weights or additional inserts made of different materials used to reduce friction between the rotary nozzle body and different types of bearings. Those different types of bearings provide for the supporting and sealing function between the rotary nozzle body and the outer housing.

Based on the state of the art, the problem to be solved was to create a very simply structured rotary nozzle, consisting of only one part and allowing having lesser friction and wearing against the inner housing wall and all the different types of supporting bearings that can be used for the sealing function

The object of the invention is accomplished by the use of the invention's rotary nozzle body adapted in its design to the outside structure of the rotary nozzle inner housing surface as described in detail hereinafter.

### SUMMARY OF THE INVENTION

The present invention is a rotary nozzle for a cleaning device, specifically for a high pressure cleaning device. The device is comprised of at least one housing with a fluid inlet or feeding duct and an outlet for the passage of the fluid. Within the housing, there is a nozzle body traversed and rotated by such fluid. According to the invention, the inner rotary nozzle body is designed in a way that it will not be in any contact with the housing's inner surface during the rotation due to a water film that is building itself up by the special design of the invention.

In addition, the friction between a bearing inside the outer housing and the rotary nozzle body that is supported by such bearing is reduced and therefore its lifetime extended independent of its type. The reduction of friction is achieved due to the fact that now the rotary nozzle body does not rotate around its own center axis anymore, but only around the center axis of the housing. The reduced friction enables the use of less sophisticated materials for the rotary nozzle body and thus allowing it to be made as one part for reduced cost.

### BRIEF DESCRIPTION OF THE DRAWINGS

FIG. 1 is a sectional view of an embodiment of the invention showing the nozzle inside of the housing; and

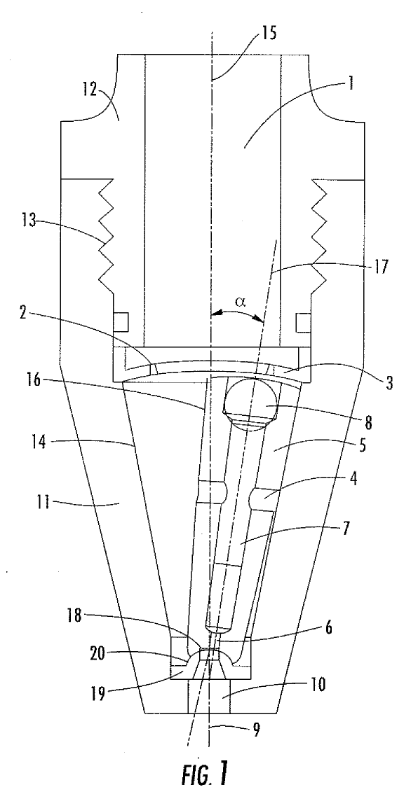

FIG. 2 is a sectional view of an embodiment of the invention showing the rotary nozzle and its specific design characteristics

### DESCRIPTION OF THE PREFERRED EMBODIMENTS OF THE INVENTION

The rotary jet body (5) of the invented type of a rotary jet is designed in a way that it can be preferably produced in one step, e.g., by a molding and plastic injection. Furthermore, it is designed so that it can function inside the rotary jet without any additional parts e.g., weights or rubber material O-rings being attached to its body.

The contact surface (18) of the rotary jet body (5) that is in direct contact with the bearing (19) in the housing, in this embodiment of the invention, is shown as a concave recess and straight with an angle (25) between 45 degrees up to 55 degrees to the center axis (17) of the rotary jet body (5), and preferably between 48 degrees to 52 degrees. The bearing (19) is shown as having a raised surface corresponding to the concave surface of the rotary jet body (5). Also, other embodiments for the rotation and sealing functions are possible. For example, the contact surface (18) of the rotary jet body (5) could also be convex and extend downwardly in which case the corresponding contact surface of the bearing (19) would be a concave recess.

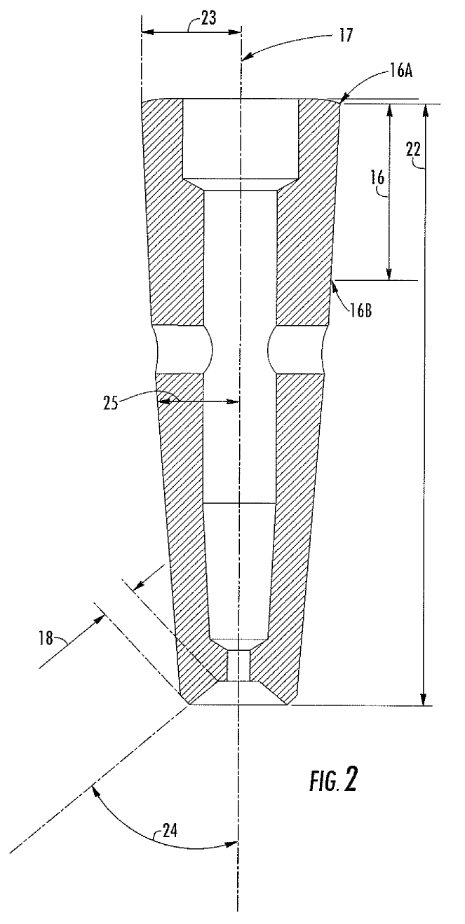

The distance between the points 16A to 16B (see FIG. 2) which defines the length of the area (16), which is a surface that builds a supporting water film between the housing (11) and the rotary jet (5) during its operation, is about 20% to 40% of the total length 22 of the rotary jet body (5), and preferably about 28% to 33% of the total length.

The angle (23) of the area (16) towards the centerline (17) of the rotary jet body (5) is designed in a way that the area (16) is substantially parallel to the angle between the inner housing surface (14) and the centerline (15) of the housing (11) during the operation of the rotary jet. The deviation of the angle (23) of the area (16) should be less than 3 degrees, and preferably less than 1.5 degrees, to achieve said close parallelism.

To allow the turning of the rotary jet body (5) inside the housing (11), it must have 2 different angles. The angle (23) on the upper side (being mostly parallel to the inner housing surface angle) and the angle (24) on the lower side are related for the angle (24) (towards the centerline (17)) to be bigger than the angle (23). The difference between the angles (23) and (24) should be at least 2 degrees.

Thus the rotary jet body (5) can “swim” on a water film that builds up between the inner housing surface 14 and the substantially parallel area 16 of the rotary jet body (5) under operation.

As a side effect there is neither additional friction nor any wear between the materials of the housing (11) and the rotary jet body (5).

As an additional benefit, the rotation of the rotary jet body (5) around its own center axis (17) while turning inside the housing (11) is very much reduced. Thus, also the wear and friction between the contact surface (18) of the rotary jet body (5) and the bearing (19) of the housing (11) is reduced and it lifetime increased.

The design of the invention is in contrary to the known designs of a rotary jet including a rotary jet body and housing comprised of at least one additional O-ring. The object of the invention is to avoid the deterioration of the housing and the rotary jet body due to friction. However, with the prior art designs, due to the permanent contact of the O-ring to the inner surface of the housing, the rotary jet body makes additional turns around its center axis, and therefore rotation speed is reduced drastically and friction is increased.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included within the scope of the following claims.

What is claimed is as follows:

1. A rotor nozzle for a high-pressure cleaning device, the nozzle comprising:
a housing having a given axis and inside surface that provides a fluid feeding duct and a fluid outlet;
a nozzle body contained within the housing and having a central axis and an upper end and a lower end, the lower end having a contact surface;
the nozzle body having an upper outer surface traversed by the fluid and rotated by the fluid about the given axis of the housing;
a bearing combined with the housing and arranged concentrically around the fluid outlet and having a central opening surrounded by a flat contact surface that engages and supports the contact surface of the lower end of the nozzle body;
the flat contact surface of the bearing being at an angle between 45 and 55 degrees relative to the central axis of the nozzle body; and
the angle between the center axis of the nozzle body and the upper outer surface of the nozzle body is such that the angle between the inner surface of the housing and the upper outer surface of the nozzle body is less than three degrees, whereby the upper outer surface of nozzle body and the inner surface of the housing are substantially parallel, and whereby the nozzle body rotates on a fluid film between the inner surface of the housing and the outer surface of the nozzle body.

2. The rotor nozzle of claim 1 in which the contact surface of the nozzle body is a concave recess and the contact surface of the bearing is convex and raised.

3. The rotor nozzle of claim 1 in which the contact surface of the nozzle body is convex and extends downwardly and the contact surface of the bearing is a concave recess.
